(19) United States
(12) Patent Application Publication
(10) Pub. No.: US 2024/0005366 A1
(43) Pub. Date: Jan. 4, 2024

(54) SYSTEM AND METHOD TO MANAGE COMMUNICATIONS OF CUSTOMERS ASSOCIATED TO A BUSINESS

(71) Applicant: BirdEye, Inc., Palo Alto, CA (US)

(72) Inventors: Naveen Gupta, Sunnyvale, CA (US); Ameya Virkar, Sunnyvale, CA (US)

(73) Assignee: BirdEye, Inc., Palo Alto, CA (US)

(21) Appl. No.: 17/856,352

(22) Filed: Jul. 1, 2022

(51) Int. Cl. G06Q 30/02; G06Q 50/00

(52) U.S. Cl. CPC G06Q 30/0281; G06Q 50/01; G06Q 30/0282; G06Q 30/0203

(57) ABSTRACT

Disclosed is a system to manage customer communications. The system is configured to collect communications associated with the customer from a plurality of communication channels. Each communication of the one or more communications has an associated form that is specific to a communication channel of the plurality of communication channels utilized for the communication; check an account status of the customer to validate the customer; combine the one or more communications associated with the customer to generate a single communication, wherein the single communication is displayed through a unified view; and enable a business owner to generate and provide one or more response communications corresponding to the one or more communications such that, to provide the one or more response communication, an automatically selected communication channel of the plurality of communication channels is utilized, wherein the automatically selected communication channel is similar to the communication channel utilized for the communication.

### TECHNICAL FIELD

The present disclosure relates generally to a system and a method to manage customer interactions, more particularly, the disclosure relates to a system and a method to manage communications of customers associates to a business in one dashboard.

### BACKGROUND

Businesses have many touch points with customers, but individual moments of interaction from a customer do not accurately capture that customer's current experience and feelings toward the business. The business may draw incorrect conclusions about the approval of their products or services based on old feedback or incomplete feedback that does not capture the entire, real-time experience of a customer. Businesses do not know which customers are unhappy, which are satisfied, and which could be potential ambassadors for their products or services.

Businesses may use the services of third-party service providers to help track, analyze and leverage the interactions with their customers. Such third-party service providers are often referred to as reputation management companies, marketing technology companies, marketing software companies or other specialized service providers. Businesses rely on such third-party service providers because such third-party service providers are adapted and well versed at obtaining, aggregating and analyzing online reviews and/or sending out and analyzing appropriate surveys and a customer's responses to survey questions. These days, there's an app for everything such as social media sites, email providers, live chat, and more, there are thousands of ways your customers can reach the business. As the business scales, the business owners need to connect with the customers on the platforms the customers are using.

Thus, there is a need for a technical solution that overcomes the aforementioned problems of conventional systems for communication management.

### SUMMARY

in an embodiment of the present disclosure, a system to manage customer communications is disclosed. The system includes processing circuitry and a non-transitory computer-readable storage medium storing one or more computer-readable instructions that when executed by the processing circuitry, cause the processing circuitry to collect communications associated with the customer from a plurality of communication channels. Each communication of the one or more communications has an associated form that is specific to a communication channel of the plurality of communication channels utilized for the communication. Further, the system, by way of the processing circuitry, checks an account status of the customer to validate the customer. The system is further configured to combine the one or more communications associated with the customer to generate a single communication, wherein the single communication is displayed through a unified view. Furthermore, the system, by way of the processing circuitry, enables a business owner to generate and provide one or more response communications corresponding to the one or more communications such that, to provide the one or more response communication, an automatically selected communication channel of the plurality of communication channels is utilized. The automatically selected communication channel is similar to the communication channel utilized for the communication.

In some embodiments, the one or more communications includes at least one of, review communications, social media communications, feedback communications, or a combination thereof.

In some embodiments, to collect the one or more communications, the processing circuitry is further configured to recognize attributes selected from one of, star ratings and customer sentiment analysis when the customer post a review on one or more third-party review sites.

In some embodiments, to collect the one or more communications, the processing circuitry is further configured to enable the business owners to create a custom questionnaire such that one or more answers provided by the customers are stored as feedback communications associated with the customer.

In some embodiments, the processing circuitry is further configured to utilize an Artificial Intelligence (AI) technique to continually learn about one or more activities of the customers associated with the business to periodically update data associated with the customer.

In some embodiments, prior to combining the one or more communications associated with the customer to generate a single communication, the processing circuitry is configured to check a spam status of the communications associated with the customer.

In some embodiments, the system further includes a database that is coupled to the processing circuitry such that the processing circuitry is configured to store the communications associated with the customer to the database.

In some embodiments, the database is configured to synchronize the communications by linking a text of the communication and a plurality of data points associated with the communications to a file and/or an account of the customer.

In some embodiments, the plurality of data points associated with the communications includes at least one of a date of the communication, a time of the communication, a source of the communication, a communication channel associated with the communication, a form of the communication, or a combination thereof.

In some embodiments, the processing circuitry is further configured to open the one or more communications when the one or more communications are attended by a business owner such that the opened one or more communications are acted upon by a set of predefined rules.

In another embodiment of the present disclosure, a method for managing one or more communications associated with a customer pertaining to a business is disclosed. The method includes: collecting, by way of processing circuitry of a server, one or more communications associated with a customer from a plurality of communication channels, wherein each communication of the one or more communications has an associated form that is specific to a communication channel of the plurality of communication channels utilized for the communication; checking, by way of the processing circuitry, an account status of the customer to validate the customer; combining, by way of the processing circuitry, the one or more communications associated with the customer to generate a single communication, wherein the single communication is displayed through a unified view; and enabling, by way of the processing circuitry, a business owner to generate and provide one or more response communications corresponding to the one or more communications such that, to provide the one or more response communication, an automatically selected communication channel of the plurality of communication channels is utilized, wherein the automatically selected communication channel is similar to the communication channel utilized for the communication.

In some embodiments, the one or more communications includes at least one of, review communications, social media communications, feedback communications, or a combination thereof.

In some embodiments, for collecting the one or more communications, the method further includes, recognizing, by way of the processing circuitry, attributes selected from one of, star ratings and customer sentiment analysis when the customer post a review on one or more third-party review sites.

In some embodiments, for collecting the one or more communications, the method further includes, enabling, by way of the processing circuitry, the business owners to create a custom questionnaire such that one or more answers provided by the customers are stored as feedback communications associated with the customer.

In some embodiments, the method further includes utilizing, by way of the processing circuitry, an Artificial Intelligence (AI) technique to continually learn about one or more activities of the customers associated with the business to periodically update data associated with the customer.

In some embodiments, prior to combining the one or more communications associated with the customer to generate a single communication, the method includes, checking, by way of the processing circuitry, a spam status of the communications associated with the customer.

In some embodiments, the method further includes storing, by way of the processing circuitry, the communications associated with the customer to a database

In some embodiments, the method further includes synchronizing, by way of the database, the communications by linking a text of the communication and a plurality of data points associated with the communications to a file and/or an account of the customer.

In some embodiments, the method further includes opening, by way of the processing circuitry, the one or more communications when the one or more communications are attended by a business owner such that the opened one or more communications are acted upon by a set of predefined rues.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 is a block diagram that illustrates a system to manage customer communications, in accordance with an embodiment of the present disclosure;

FIG. 2 is a block diagram that illustrates a server of the system of FIG. 1, in accordance with an embodiment of the present disclosure;

FIG. 3 illustrates a flow chart that depicts a method to display a unified view of all communications of the customer journey to a business across various channels and touchpoints, in accordance with an exemplary embodiment of the disclosure.

FIG. 4 illustrates an inbox dashboard having a plurality of inboxes specific to one or more customers of a business, in accordance with an embodiment of the present disclosure; and

FIG. 5 illustrates a flowchart of a method for managing one or more communications associated with a customer pertaining to a business, in accordance with an embodiment of the present disclosure.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

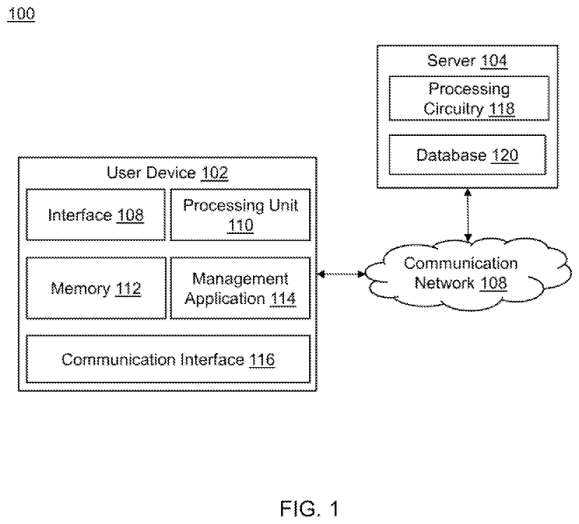

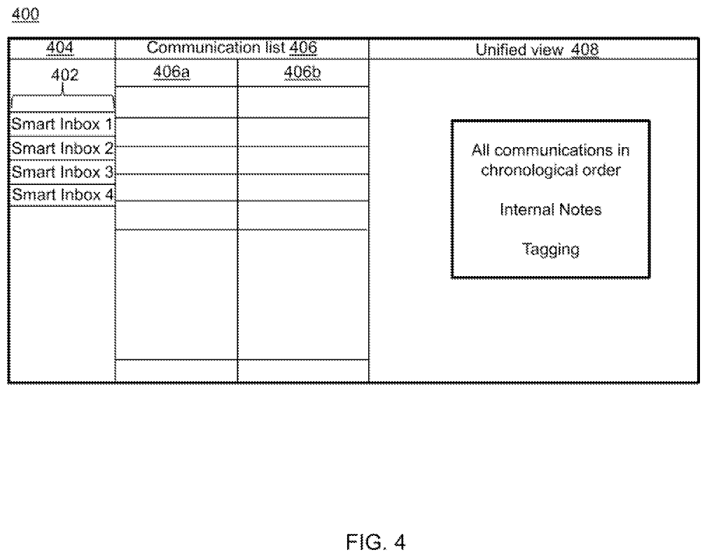

FIG. 1 is a block diagram that illustrates a system 100 to manage customer communications, in accordance with an embodiment of the present disclosure. The system 100 may be configured to gather and organize the communications (hereinafter interchangeably referred to as “interactions”) associated to a business customer from a plurality of sources (i.e., a plurality of communication channels) for viewing and follow-up in an organized, easy to navigate inbox dashboard 400 (as shown later in FIG. 4). The system 100 may include a user device 102 and a server 104. In the illustrated embodiment of FIG. 1, the user device 102 and the server 104 are communicatively coupled to each other via a communication network 106. In other embodiments, the user device 102 and the server 104 may be communicably coupled through separate communication networks established therebetween.

The user device 102 may be adapted of facilitate a user to input data, receive data, and/or transmit data within the system 100. In some embodiments of the present disclosure, the user may include, but is not limited to, a customer of a business, an administrator of the system 100, a business owner, a representative of the business, and the like. It will be apparent to a person of ordinary skill in the art that the user may be any personnel using the system 100, without deviating from the scope of the disclosure. In some embodiments of the present disclosure, the user device 102 may include, but is not limited to, a desktop, a notebook, a laptop, a handheld computer, a touch sensitive device, a computing device, a smart phone, a smart watch, and the like. It will be apparent to a person of ordinary skill in the art that the user device 102 may include any device/apparatus that is capable of manipulation by the user. The user device 102 may include an interface 108, a processing unit 110, and a memory 112.

The interface 108 may include an input interface for receiving inputs from the user. Examples of the input interface may include, but are not limited to, a touch interface, a mouse, a keyboard, a motion recognition unit, a gesture recognition unit, a voice recognition unit, or the like. Embodiments of the present disclosure are intended to include or otherwise cover any type of the input interface including known, related art, and/or later developed technologies. The interface 108 may further include an output interface for displaying (or presenting) an output to the customer. Examples of the output interface may include, but are not limited to, a display device, a printer, a projection device, and/or a speaker. Examples of the interface 108 may include, but are not limited to, a digital display, an analog display, a touch screen display, a graphical customer interface, a website, a webpage, a keyboard, a mouse, a light pen, an appearance of a desktop, and/or illuminated characters.

The processing unit 110 may include suitable logic, instructions, circuitry, and/or interfaces for executing various operations, such as one or more operations associated with the user device 102. In some embodiments of the present disclosure, the processing unit 110 may be configured to control the one or more operations executed by the user device 102 in response to an input received at the user device 102 from the user. Examples of the processing unit 110 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 110 including known, related art, and/or later developed technologies.

The memory 112 may be configured to store logic, instructions, circuitry, interfaces, and/or codes of the processing unit 110, data associated with the user device 102, and data associated with the system 100. Examples of the memory 112 may include, but are not limited to, a Read-Only Memory (ROM), a Random Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Embodiments of the present disclosure are intended to include or otherwise cover any type of the memory 112 including known, related art, and/or later developed technologies.

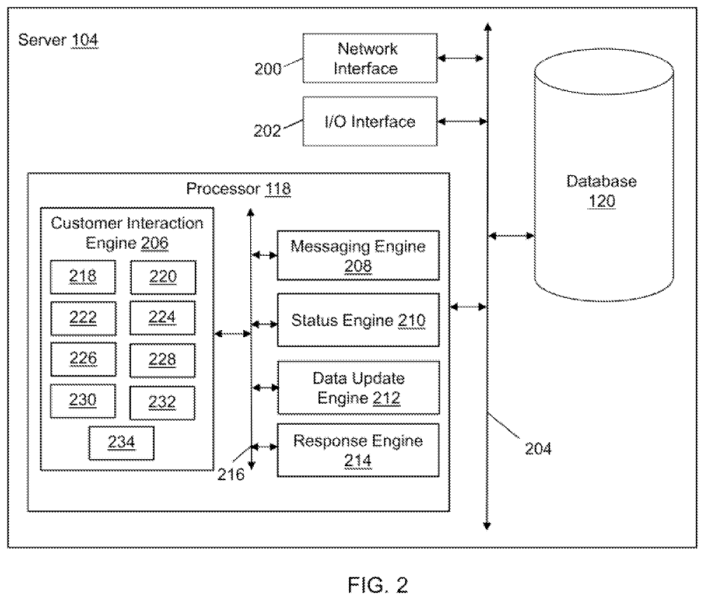

In some embodiments of the present disclosure, the user device 102 may further include one or more computer executable applications configured to be executed by the processing unit 110. The one or more computer executable applications may include suitable logic, instructions, and/or codes for executing various operations associated with the system 100. The one or more computer executable applications may be stored in the memory 112. Examples of the one or more computer executable applications may include, but are not limited to, an audio application, a video application, a social media application, a navigation application, and the like. Preferably, the one or more computer executable applications, may include a management application 114. Specifically, one or more operations associated with the management application 114 may be controlled by the server 104 that will be explained in detail in FIG. 2.

The user device 102 may further include a communication interface 116. The communication interface 116 may be configured to enable the user device 102 to communicate with the server 104 and other components of the system 100 over the communication network 106. Examples of the communication interface 116 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface 116 may include any device and/or apparatus capable of providing wireless and/or wired communications between the user device 102 and the server 104.

The server 104 may be a network of computers, a software framework, or a combination thereof, that may provide a generalized approach to create the server implementation. Examples of the server 104 may include, but are not limited to, personal computers, laptops, mini-computers, mainframe computers, any non-transient and tangible machine that can execute a machine-readable code, cloud-based servers, distributed server networks, or a network of computer systems. In some embodiments of the present disclosure, the server 104 may be realized through various web-based technologies such as, but not limited to, a Java web-framework, a .NET framework, a personal home page (PHP) framework, or any web-application framework. The server 104 may include one or more processing circuitries of which processing circuitry 118 is shown and a non-transitory computer-readable storage medium 120.

The processing circuitry 118 may be configured to execute various operations associated with the system 100. The processing circuitry 118 may be configured to host and enable the management application 114 running on (and/or installed on) the user device 102 to execute the one or more operations associated with the system 100 by communicating one or more commands and/or instructions over the communication network 106. Examples of the processing circuitry 118 may include, but are not limited to, an ASIC processor, a RISC processor, a CISC processor, a FPGA, and the like. Embodiments of the present disclosure are intended to include and/or otherwise cover any type of the processing circuitry 118 including known, related art, and/or later developed technologies.

The non-transitory computer-readable storage medium 120 (hereinafter interchangeably referred to and designated as “the database 120”) may be configured to store the logic, instructions, circuitry, interfaces, and/or codes of the processing circuitry 118 for executing various operations. The database 120 may be further configured to store therein, data associated with the users registered with the system 100, and the like. It will be apparent to a person having ordinary skill in the art that the database 120 may be configured to store various types of data associated with the system 100, without deviating from the scope of the present disclosure. Examples of the database 120 may include but are not limited to, a Relational database, a NoSQL database, a Cloud database, an Object-oriented database, and the like. Further, the database 120 may include associated memories that may include, but is not limited to, a ROM, a RAM, a flash memory, a removable storage drive, a HDD, a solid-state memory, a magnetic storage drive, a PROM, an EPROM, and/or an EEPROM. Embodiments of the present disclosure are intended to include or otherwise cover any type of the database 120 including known, related art, and/or later developed technologies. In some embodiments of the present disclosure, a set of centralized or distributed network of peripheral memory devices may be interfaced with the server 104, as an example, on a cloud server.

The communication network 106 may include suitable logic, circuitry, and interfaces that may be configured to provide a plurality of network ports for transmission and reception of data related to operations of various entities (such as the user device 102 and the server 104) of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the customer device 102 and the server 104. The communication data may be transmitted or received, via the communication protocols. Examples of the communication protocols may include, but are not limited to. Hypertext Transfer Protocol (HTTP), File Transfer Protocol (FTP), Simple Mail Transfer Protocol (SMTP), Domain Network System (DNS) protocol, Common Management interface Protocol (CMIP), Transmission Control Protocol and Internet Protocol (TCP/IP), Customer Datagram Protocol (UDP), Long Term Evolution (LTE) communication protocols, or any combination thereof.

In operation, the system 100, by way of the components such as, but not limited to, the user device 102 and the server 104, may be configured to manage customer communications. The system 100 may be configured to collect communications associated with the customer from a plurality of communication channels. In some aspects of the present disclosure, the communication channels may include, but is not limited to, a Short Message Service (SMS), an email, a Whatsapp® message, an Apple® message, an Instagram® message, a Facebook® Message, a Google® Business Message, a review, a survey, an appointment, a payment, and the like. Embodiments of the present disclosure are intended to include and/or otherwise cover any type of the communication channels, without deviating from the scope of the present disclosure. Specifically, each communication of the one or more communications has an associated form that is specific to a communication channel of the plurality of communication channels utilized for the communication. In some embodiments of the present disclosure, to collect the one or more communications, the system 100 may be further configured to recognize attributes selected from one of, star ratings and customer sentiment analysis when the customer post a review on one or more third-party review sites. In some embodiments of the present disclosure, to collect the one or more communications, the system 100 may be configured to enable the business owners to create a custom questionnaire such that one or more answers provided by the customers are stored as feedback communications associated with the customer. The system 100 may be further configured to check an account status of the customer to validate the customer. The system 100 may be further configured to combine the one or more communications associated with the customer to generate a single communication, wherein the single communication is displayed through a unified view. In some embodiments of the present disclosure, prior to combining the one or more communications associated with the customer to generate a single communication, the system 100 may be configured to check a spam status of the communications associated with the customer. The system 100 may be further configured to enable a business owner to generate and provide one or more response communications corresponding to the one or more communications such that, to provide the one or more response communication, an automatically selected communication channel of the plurality of communication channels is utilized. The automatically selected communication channel is similar to the communication channel utilized for the communication. Thus, the system 100 may enable the business owners to provide response communications to the customer without having to switch between the communication channels.

FIG. 2 is a block diagram that illustrates the server 104 of FIG. 1, in accordance with an embodiment of the present disclosure. The server 104 may include the processing circuitry 118 and the database 120. The server 104 may further include a network interface 200 and an input/output (I/O) interface 202. The processing circuitry 118, the database 120, the network interface 200, and the I/O interface 202 may communicate with each other by way of a first communication bus 204. In some embodiments of the present disclosure, the processing circuitry 118 may include a customer interaction engine 206, a messaging engine 208, a status engine 210, a data update engine 212, and a response engine 214 that communicate with each other by way of a second communication bus 216. It will be apparent to a person having ordinary skill in the art that the server 104 is for illustrative purposes and not limited to any specific combination of hardware circuitry and/or software.

The network interface 200 may include suitable logic, circuitry, and interfaces that may be configured to establish and enable a communication between the server 104 and different components of the system 100 (e.g., the user device 102), via the communication network 106. The network interface 200 may be implemented by use of various known technologies to support wired or wireless communication of the server 104 with the communication network 106. The network interface 200 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

The I/O interface 202 may include suitable logic, circuitry, interfaces, and/or code that may be configured to receive inputs (e.g., orders) and transmit server outputs via a plurality of data ports in the server 104. The I/O interface 202 may include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker.

The processing circuitry 118 may be configured to manage one or more communications of a user associated to a business by way of the customer interaction engine 206, a messaging engine 208, a status engine 210, a data update engine 212, and a response engine 214. The customer interaction engine 206 may be configured to manage a plurality of interactions of one or more customers (hereinafter collectively referred to and designated as “the customers” and individually referred to and designated as “the customer”) pertaining to a business. The customer interaction engine 206 may include a review engine 218, a survey engine 220, a campaign engine 222, a social media engine 224, a communications engine 226, an appointment engine 228, a referral engine 230, a payment engine 232, and a processing engine 234. Specifically, when the customers post one or more reviews (hereinafter collectively referred to and designated as “the reviews”) pertaining to the business on one or more third-party review sites (not shown), the review engine 218 may be configured to aggregate the reviews. In other words, the review engine 218 may be configured to capture the reviews posted by the customers pertaining to the business across the one or more third-party review sites to identify review communications. The review engine 218 may be further configured to aggregate the review communications pertaining to the business by periodically scanning the one or more third-parry review sites on which the business is listed. Furthermore, the review engine 218 may be configured to process and analyze the review communications to recognize attributes such as, but not limited to, star ratings, customer sentiments, customer details, and the like, to recognize the customer that posted the reviews. In some embodiments of the present disclosure, the review engine 218 may be further configured to associate data regarding the review communications to a file and/or an account associated to the recognized customer.

The survey engine 220 may be configured to enable a business owner of the business to create a custom questionnaire for the customers interested and/or associated with the business. Specifically, the business owner of the business may create the custom questionnaire by way of a survey creation menu (not shown) of the inbox dashboard 400 that may be displayed by way of the interface 108 of the user device 102. Further, the survey engine 220 may be configured to provide the custom questionnaire created for the customers to the campaign engine 222 such that the campaign engine 222 transmits the custom questionnaire to the customers by way of a method such as, but not limited to, a text message, an email, a push notification, and the like. Embodiments of the present disclosure are intended t include and/or otherwise cover any type of the method for transmitting the custom questionnaire to the customers, including known, related, and later developed technologies. The survey engine 220 may be further configured to gather feedback from the customers by analyzing the answers provided by the customers in response to the custom questionnaire to generate survey communications. The social engine 224 may be configured to aggregate one or more posts and/or comments posted by the customer on a social media page associated to the customer and/or a profile of the business to generate social media communications. The social engine 214 may be further configured to link the aggregated social media communications to the file and/or the account associated to the customer having an active account with a martech company registered with the system 100.

The communications engine 226 may be configured to handle one or more direct incoming and/or outgoing communications with the customer that may be executed by way of a text message, an email, and the like. The communications engine 226 may be further configured to transmit a text message and/or an email the customers. In some embodiments of the present disclosure, the communications engine 226 may be configured transmit the text message and/or the email in bulk to multiple customers. In some embodiments of the present disclosure, the communications engine 226 may be configured to transmit the text message and/or the email to the customers based on predefined rules that triggers the text message and/or the email such that the text message and/or the email are sent to the customers when the predefined rules are fulfilled. For example, when the predefined rules include a triggering of the text message and/or the email when a customer leaves a review on Google®, the customer gets a “thank you message”, the communications engine 226 may be configured to transmit the text message and/or the email including the “thank you message” to the customer shortly after the customer posts the review. The communications engine 226 may be further configured to link the incoming and/or outgoing communications to the file and/or the account associated to the customer having an active account with a martech company registered with the system 100. As used herein, the martech company refers to any marketing technology companies that may be involved in managing the communications associated with customers of a business.

The appointment engine 228 may be configured to manage one or more appointments of the customer and one or more vendors to receive and provide services, respectively. The appointment engine 228 may be further configured to book the appointments with the customers as per a service request raised by the customers and further provide the appointment-related communication to the customers. In some embodiments of the present disclosure, the appointment engine 228 may be configured to extract information associated with the appointments of the customers and/or the one or more vendors from a Customer Relationship Management (CRM) account of the business, the file associated to the customer, and/or the account associated to the customer to generate appointment communications. Further, the appointment engine 228 may be configured to link the appointment communications corresponding to the appointments to the file and/or the account associated to the customer having an active account with the martech company registered with the system 100.

The referral engine 230 may be configured to enable the business owners to send out communications that asks the customers to refer friends and/or families to buy products and/or to schedule services from the business. Similar to the communications engine 226, the referral engine 230 may be configured to send requests to a target customer and/or a group of customers based on predefined rules. The referral engine 230 may be further configured to link all the referral communications including one or more referral requests, one or more actions taken by a referee, and one or more action taken by the customer to the file and/or the account associated to the customer having an active account with the martech company registered with the system 100. The payment engine 232 that may be configured to aggregate one or more payment communications (e.g., invoices, requests for payments, transaction outcomes, and the like) sent to a customer, to a specific group of the customers, or individuals based on rules established by the business. The payment engine 232 may be configured to link the one or more payment communications to the file and/or the account associated to the customer having an active account with the martech company registered with the system 100. Specifically, the one or more communication associated with the customer pertaining to the business may include all the communications aggregated by the review engine 218, the survey engine 220, the campaign engine 222, the social media engine 224, the communications engine 226, the appointment engine 228, the referral engine 230, and the payment engine 232.

The processing engine 234 may be configured to analyze and process the communications associated with the customer by accessing the account and/or the file of the customer from a database of the martech company and/or in the CRM system of the business. The analyzes and processed communications associated with the customer may be utilized in future communications and/or interactions associated with the customer. The processing engine 234 may be further configured to utilize an Artificial Intelligence (AI) technique to continually learns about one or more activities of a customer associated with the business such that the processing engine 234 updates the file and/or account associated with the customer in real time. The updates the file and/or account associated with the customer may allow future interactions with the customer to be both accurate and contemporaneous that may provide an enhanced experience to the customer. In some embodiments of the present disclosure, the AI technique may include, but is not limited to, naive bayes, decision tree, random forest, support vector machines, k nearest neighbors, linear regression, lasso regression, logistic regression, and the like. Embodiments of the present disclosure are intended to include and/or otherwise cover any type of the AI technique, including known, related, and later developed techniques.

Upon receipt of the communications by the customer interaction engine 206, the messaging engine 208 may be activated. The messaging engine 208 may be configured to identify a form of one or more messages associated with the communications. The form of the one or more messages may vary and may typically correspond to a communication channel used by the customer. In some embodiments of the present disclosure, the communication channel may include, but is not limited to, a text message, a SMS, an email, a social media post, a social media comment, a review post by the customer at one or more third-party review sites, and the like. Specifically, the communication channel may include any type of the communication channels through which the customer interaction engine 206 receives the communications associated with customer and that pertains to a business.

The messaging engine 208 may be further configured to validate each of the communications. Specifically, to validate each of the communications, the messaging engine 208 may be configured to determine an account status of the customer associated with the communications within the database of the martech company and/or within the CRM of the business. When the messaging engine 208 determines that the account status of the customer is “deactivated”, the messaging engine 208 rejects the communications. On the contrary, when the messaging engine 208 determines that the account status of the customer is “activated”, the messaging engine 208 checks a spam status of the communications. In some embodiments of the present disclosure, to check a spam status of the communications, the messaging engine 208 may be configured to identify any type of abusive language used in the communications. When the messaging engine 208 determines that the span status of the communications is “spam detected”, the messaging engine 208 rejects the communications. On the contrary, when the messaging engine 208 determines that the spam status of the communications is “spam not detected”, the messaging engine 208 combines the communications associated to the customer under the file and/or a string in the inbox dashboard 400 (as shown later in FIG. 4). Specifically, the messaging engine 208 may be configured to combine the communications associated with the customer from different communications channels and map within the communications under a single communication that is displayed through the inbox dashboard 400.

The status engine 210 may be configured to mark a status of the communications as “unread” when the status engine 210 determines that the communications is not viewed by the business. Specifically, the communications having the status as “unread” may be marked in first communications list 406a (as shown later in FIG. 4). In some embodiments of the present disclosure, the status of the communications such as, (i) same communication sent out to multiple customers as mass communication and (ii) automatic replies that are preconfigured in the system 100 and goes out without any manual intervention whenever a predefined rule is triggered, may not be updated to “unread”. In some embodiments of the present disclosure, when the communication status engine 210 determines that the communications is opened (i.e., read) by the business, the status engine 210 updates the status of the communications as “read” such that any user (e.g., a representative of the business, a business owner) knows that the communications is already read. Specifically, the communications having the status as “unread” may be marked in second communications list 406b (as shown later in FIG. 4). Further, when the status engine 210 determines that the business has transited a response corresponding to the communications, the status engine 210 may be configured to update status of the communications as “closed”. Specifically, the communications having the status as “unread” may be marked in first communications list 406b. Specifically, the status of the communication enables the business to know exactly which communication is seen, responded to, or “actioned” in one, simple to understand part of a dashboard (as shown later in FIG.). In some embodiments of the present disclosure, the status engine 210 may be configured to enable the business owner to set rules such that a communication is not moved from open to closed until a set of responsible parties associated to the business has reviewed the communications. For example, the business owner may set a rule in the inbox that Sr. Director of Marketing and Director of Customer Marketing must review a communication and/or interaction before it is updated or moved and, as a result, the communication may not be moved or recategorized (or, tagged with a new status) until all designated parties have reviewed the communication or taken action on the communication.

In some embodiments of the present disclosure, the status engine 210 may be further configured to update the status of the communication as “open” and further move the communication to first communication list 406a when the status engine 210 determines that the communication is closed and/or reviewed, upon being displayed in a unified view 408 (as shown later in FIG. 4). Specifically, in such context, the status “open” represents that the communication is open for the business owners to take action and/or for pre-set rules to act upon. Once the communication is responded to and/or “actioned,” the status engine 210 may be configured to move the communication from the first communication list 406a to the second communication list 406b. Further, the status engine 210 may be further configured to store the communication that is moved from the first communication list 406a to the second communication list 406b into the database 120 such that the database 120 synchronizes the communications with the file and/or the account of the customer. In some embodiments of the present disclosure, the database 120 may be further configured to synchronizes the communications with the file and/or the account of the customer in the CRM of the business. Specifically, the database 120 may be configured to synchronize the communications by linking a text of the communication and a plurality of data points associated with the communications to the file and/or the account of the customer. In some embodiments of the present disclosure, the plurality of data points may include, but is not limited to, a date of the communication, a time of the communication, a source of the communication, a communication channel associated with the communication, a form of the communication, and the like. Embodiments of the present disclosure are intended to include and/or otherwise cover any type of the data points associated with the communications that may provide details corresponding to the communications, without deviating from the scope of the present disclosure.

The data update engine 212 may be configured to extract most recent communications associated with a customer that pertains to a business based on the communications received at the customer interaction engine 206. Further, the data update engine 212 may be configured to continually updated and mirror in the unified view 706 as well as in the first and second communications lists 702 and 704, the extracted most recent communications associated with the customer to provide a good user experience by ensuring the business is using most up-to-date data (e.g., the communications associated to the customer). In some embodiments of the present disclosure, the data update engine 212 may be configured to push the most recent communications associated with the customer to the interface 108 of the user device 102 of an active user of the inbox dashboard 400 such that recent communications appear on the interface 108 via the inbox dashboard 400 of the active users without the need to refresh.

The response engine 214 may be configured to enable the business owners to take manual action with respect to the communication moved to the first and second communication lists 702 and 704. In some embodiments of the present disclosure, the response engine 214 may be configured to enable the business owners to set pre-configure rules that may trigger email notifications and/or other automated responses. The response engine 214 may be configured to enable the business owners to select a customer (i.e., an inbox associated with the customer) to which an outgoing communication is to be sent. As soon as the selection is made, the response engine 214 may be configured to generate a request that transforms the request into a filter object associated with the selected inbox. The response engine 214 is further configured to tag the filter object with a relevant sorting rule associated with the selected inbox such that based on the filter and the sorting rules a query is generated to fetch the communication object (i.e., the communications associated with the customer) from the database 120. The query response is subsequently converted into a conversation response that can be displayed within the specific inbox. The response engine 214 may be configured to publish the final communication to the Inbox where the final communication is displayed to the business owners as another communication. The response engine 214 may be further configured to check the spam status of a response communication created by the business owner corresponding to the displayed communication that is being attended by the business owner. When the response engine 214 determines that the spam status of the response communication is “spam not detected” the response engine 214 selects the communication channel for the outgoing response communication automatically based on the last used communication channel. In some embodiments of the present disclosure, the response engine 214 may be configured to enable the business owner to override the automatically selected communication channel. Once the communication channel is selected, the response engine 214 enables the business owners to initiate the response communication manually. In some embodiments, the response communication may be initiated based on pre-set rules that may trigger an automated response communication. Alternatively, when the response engine 214 determines that the spam status of the communications associated with the customer is “spam detected”, the response engine 214 rejects the communication and further flag the corresponding communication as spam in the dashboard of the inbox 700. In an exemplary scenario, depending on the communication channel of the communication, the response communication may be a response to a review or any outgoing message. When the response communication is the response to the review, the response engine 214 posts the response communication on a public third-party tool via a review response flow. For all other communication channels, the communication is private between the customer and the business.

As soon as the response communication is sent, the response engine 214 may be configured to update the recent messages in the communications to the latest message and a contact of the customer is tagged with the business user that has sent the outgoing response communication. Further, the response engine 214 may be configured to move the lasts communication (i.e., the response communication) to the top of the second communication list 704. Further, the response engine 214 may be configured to update all communications displayed to other users on the Inbox 700 by using mirroring such that also all the new updates for all the business owners are visible in the inbox associated to the customer. In some embodiments of the present disclosure, the response engine 214 may be further configured to enable the users to enable push notifications such that the users are aware of incoming and/or outgoing communications.

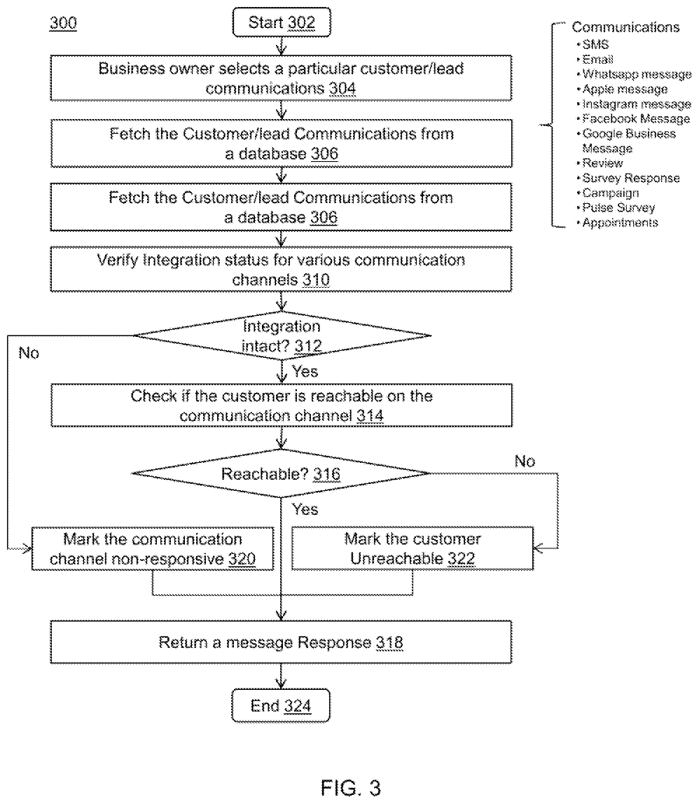

FIG. 3 illustrates a flow chart that depicts a method 300 to display a unified view of all communications of the customer journey to the business across various channels and touchpoints, in accordance with an exemplary embodiment of the disclosure. Referring now to FIG. 3, the method 300 may generally start at step 302, where the system 100 may receive the communications associated with a customer pertaining to a business.

At step 304, the system 100 enables the business owner to select a customer from a list of customers associated with the business which in turn opens the unified view (as shown later in FIG. 4).

At step 306, the system 100 fetches the communications associated with the customer from the database 120. Specifically, upon selecting the communication, a call is made to the datastore 120 to fetch the unified communication details belonging to the customer.

At step 308, the system 100 marks the communication “unread” for the business owners that facilitates the business owners in determining which communications are read.

At step 310, the system 100 checks an integration status of the business location on which the communication occurred with the respective communication channels (e.g., Facebook®, Instagram®, Google Business Messaging. and the like).

At step 312, when the system 100 determines that the integration is intact, the method 600 proceeds to a step 314, otherwise the method 300 proceeds to a step 320.

At step 314, the system 100 may check a user reachability specific to the communication channels.

At step 316, when the system 100 determines that the user reachability specific to the communication channels is available, the method 300 proceed to a step 318, otherwise when the user reachability specific to the communication channels is available, for example, on Facebook®, a customer becomes unreachable 24 hours after an incoming message is received, the method 300 proceeds to the step 322.

At step 318, the system 100 provides the response communication to the customer through the selected communication channel.

At the step 320, the system 100 flags the respective integration as broken and display the same error or“broken” message to the business owner when the business owner selects that communication channel for communication with the customer. In such scenario, the business owner manually selects a different action that the business owner deems appropriate.

At the step 322, the system 100 flags the communication channel specific customer unreachability and displays the same to the business owner when the business owner selects that communication channel for communication with the customer. The method 300 ends at step 324.

FIG. 4 illustrates the inbox dashboard 400 having a plurality of inboxes 402 specific to the customers of a business, in accordance with an embodiment of the present disclosure.

The layout of the inbox dashboard 400 has three major components such as a navigation 404, a communication list for each customer 406, and a unified view 408 for all of customers of the business showing all communications with that customer in chronological order. The navigation 404 of the inbox dashboard 400 includes folders (i.e., the plurality of inboxes 402 specific to the customers of the business) in which all the communications and interactions are organized. Each customer inbox the plurality of inboxes 402 has filter rules based on a property of the communication present in the communications lists 406.

The business owners can see different lists of communications in the communications lists 406 by navigating between different customer inboxes shown in the navigation 404. Furthermore, the inboxes can also be created by the business owners based on set preferences by applying a set of filters on properties of the communications. The property of the communications may include, but is not limited to, incoming channel, outgoing channel, duration, read/unread status, open/closed, tagging, and the like. The communications list 406 may include a list of all the customers showing all communications from or to that customer, or interactions with that customer which has been completed. The communications list 406 is further divided into the first communication list 406a (i.e., the open communications list) and the second communications list 406b (i.e., the closed communications list). The first and second communications lists 406a and 406b may facilitate the business owners to track the communications on which they need to take any action. The first communications list 406a includes all communications that need some response. On the contrary, the second communications list 406b may include all communications that do not need any action from the business owners. In some embodiments of the present disclosure, the business owners can manually move conversation from the first communications list 406a to the second communications list 406b and vice versa as per a current status of the customer journey.

When the business owner selects any contact (i.e., the customer) from the first and second communications lists 406a and 406b, the business owners can see full width of communications that has happened with the customer in the unified view 408. Specifically, the unified view 408, the business owner and any personnel associated with the business have an option to add messages for other team members associated with the business to see and “action” in the unified view 408. Such messages with the business are called internal notes and are not sent to the customer and are only visible to the team members associated with the business. In some embodiments of the present disclosure, the team members associated with the business can also tag other team members to assign them the communication so that they know that they have to take the next action on this communication. All communications and notes are organized in a chronological order in the unified view 408 and are only visible to the business owners.

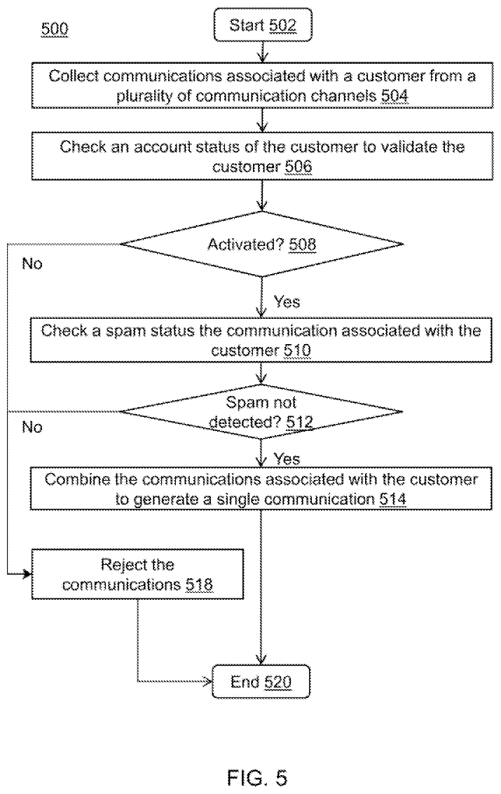

FIG. 5 illustrates a flowchart of a method 500 for managing one or more communications associated with a customer pertaining to a business, in accordance with an embodiment of the present disclosure. The method 500 generally starts at step 502.

At step 504, the system 100 collects one or more communications associated with the customer from the plurality of communication channels. Each communication of the one or more communications has an associated form that is specific to a communication channel of the plurality of communication channels utilized for the communication.

At step 506, the system 100 checks an account status of the customer to validate the customer.

At step 508, when the system 100 determines that the account status of the customer is “activated”, the method 500 proceeds to a step 510, on the contrary, when the system 100 determines that the account status of the customer is “deactivated”, the method 500 proceeds to a step 516.

At step 510, the system 100 checks the spam status of the communications associated with the customer.

At step 512, when the system 100 determines that the spam status of the communications associated with the customer is “spam not detected”, the method 500 may proceed to a step 514, on the contrary, when the system 100 determines that the spam status of the communications associated with the customer is “spam detected”, the method 500 may proceed to the step 518.

At step 514, the system 100 combines the one or more communications associated with the customer to generate a single communication such that the single communication is displayed through a unified view 408 of the dashboard 400.

At step 516, the system 100 enables a business owner to generate and provide one or more response communications corresponding to the one or more communications such that, to provide the one or more response communication, an automatically selected communication channel of the plurality of communication channels is utilized. The automatically selected communication channel is similar to the communication channel utilized for the communication.

At step 518, the system 100 rejects the communication. The method 500 ends at step 520.

Certain terms are used throughout the following description and claims to refer to particular features or components. As one skilled in the art will appreciate, different persons may refer to the same feature or component by different names. This document does not intend to distinguish between components or features that differ in name but not structure or function. While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

Further comprising utilizing, by way of the processing circuitry, an Artificial Intelligence (AI) technique to continually learn about one or more activities of the customers associated with the business to periodically update data associated with the customer.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims. Further, unless stated otherwise, terms such as “first” and “second” are used to arbitrarily distinguish between the elements such terms describe. Thus, these terms are not necessarily intended to indicate temporal or other prioritization of such elements.

The various embodiments further can be implemented in a wide variety of operating environments, which in some cases can include one or more user computers, computing devices or processing devices which can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols and such a system also includes a number of workstations running any of a variety of commercially-available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

Whereas many alterations and modifications of the present invention will no doubt become apparent to a person of ordinary skill in the art after having read the foregoing description, it is to be understood that the particular embodiments shown and described by way of illustration are in no way intended to be considered limiting.

1. A system, comprising processing circuitry and a non-transitory computer-readable storage medium storing one or more computer-readable instructions that when executed by the processing circuitry, cause the processing circuitry to:
collect one or more communications associated with a customer from a plurality of communication channels, wherein each communication of the one or more communications has an associated form that is specific to a communication channel of the plurality of communication channels utilized for the communication;
check an account status of the customer to validate the customer;
combine the one or more communications associated with the customer to generate a single communication, wherein the single communication is displayed through a unified view; and
enable a business owner to generate and provide one or more response communications corresponding to the one or more communications such that, to provide the one or more response communication, an automatically selected communication channel of the plurality of communication channels is utilized, wherein the automatically selected communication channel is similar to the communication channel utilized for the communication.

2. The system of claim 1, wherein the one or more communications comprises at least one of, review communications, social media communications, feedback communications, or a combination thereof.

3. The system of claim 1, wherein, to collect the one or more communications, the processing circuitry is further configured to recognize attributes selected from one of, star ratings and customer sentiment analysis when the customer post a review on one or more third-party review sites.

4. The system of claim 1, wherein, to collect the one or more communications, the processing circuitry is further configured to enable the business owners to create a custom questionnaire such that one or more answers provided by the customers are stored as feedback communications associated with the customer.

5. The system of claim 1, wherein the processing circuitry is further configured to utilize an Artificial Intelligence (AI) technique to continually learn about one or more activities of the customers associated with the business to periodically update data associated with the customer.

6. The system of claim 1, wherein, prior to combining the one or more communications associated with the customer to generate the single communication, the processing circuitry is configured to check a spam status of the communications associated with the customer.

7. The system of claim 1, further comprising a database that is coupled to the processing circuitry such that the processing circuitry is configured to store the communications associated with the customer to the database.

8. The system of claim 7, wherein the database is configured to synchronize the communications by linking a text of the communication and a plurality of data points associated with the communications to a file and/or an account of the customer.

9. The system of claim 7, wherein the plurality of data points associated with the communications comprises at least one of, a date of the communication, a time of the communication, a source of the communication, a communication channel associated with the communication, a form of the communication, or a combination thereof.

10. The system of claim 1, wherein the processing circuitry is further configured to open the one or more communications when the one or more communications are attended by a business owner such that the opened one or more communications are acted upon by a set of predefined riles.

11. A method for managing one or more communications associated with a customer pertaining to a business, the method comprising:
collecting, by way of processing circuitry of a server, one or more communications associated with a customer from a plurality of communication channels, wherein each communication of the one or more communications has an associated form that is specific to a communication channel of the plurality of communication channels utilized for the communication;
checking, by way of the processing circuitry, an account status of the customer to validate the customer;
combining, by way of the processing circuitry, the one or more communications associated with the customer to generate a single communication, wherein the single communication is displayed through a unified view; and
enabling, by way of the processing circuitry, a business owner to generate and provide one or more response communications corresponding to the one or more communications such that, to provide the one or more response communication, an automatically selected communication channel of the plurality of communication channels is utilized, wherein the automatically selected communication channel is similar to the communication channel utilized for the communication.

12. The method of claim 11, wherein the one or more communications comprises at least one of, review communications, social media communications, feedback communications, or a combination thereof.

13. The method of claim 11, wherein, for collecting the one or more communications, the method further comprising, recognizing, by way of the processing circuitry, attributes selected from one of, star ratings and customer sentiment analysis when the customer post a review on one or more third-party review sites.

14. The method of claim 11, wherein, for collecting the one or more communications, the method further comprising, enabling, by way of the processing circuitry, the business owners to create a custom questionnaire such that one or more answers provided by the customers are stored as feedback communications associated with the customer.

15. The method of claim 11, further comprising utilizing, by way of the processing circuitry, an Artificial Intelligence (AI) technique to continually learn about one or more activities of the customers associated with the business to periodically update data associated with the customer.

16. The method of claim 11, wherein, prior to combining the one or more communications associated with the customer to generate the single communication, the method comprising, checking, by way of the processing circuitry, a spam status of the communications associated with the customer.

17. The method of claim 11, further comprising storing, by way of the processing circuitry, the communications associated with the customer to a database.

18. The method of claim 17, further comprising synchronizing, by way of the database, the communications by linking a text of the communication and a plurality of data points associated with the communications to a file and/or an account of the customer.

19. The method of claim 17, wherein the plurality of data points associated with the communications comprises at least one of, a date of the communication, a time of the communication, a source of the communication, a communication channel associated with the communication, a form of the communication, or a combination thereof.

20. The method of claim 1, further comprising opening, by way of the processing circuitry, the one or more communications when the one or more communications are attended by a business owner such that the opened one or more communications are acted upon by a set of predefined rules.
